(19) United States
(12) Patent Application Publication
(10) Pub. No.: US 2025/0181516 A1
(43) Pub. Date: Jun. 5, 2025

(54) METHOD AND APPARATUS FOR TRANSLATING VIRTUAL ADDRESS FOR PROCESSING-IN MEMORY

(71) Applicant: UIF (University Industry Foundation), Yonsei University, Seoul (KR)

(72) Inventors: Eui-Young CHUNG, Seoul (KR); Duheon CHOI, Hwaseong-si (KR); Taeyang JEONG, Seoul (KR)

(73) Assignee: UIF (University Industry Foundation), Yonsei University, Seoul (KR)

(21) Appl. No.: 18/963,212

(22) Filed: Nov. 27, 2024

(30) Foreign Application Priority Data
Dec. 1, 2023 (KR) 10-2023-0172560

(51) Int. Cl. G06F 12/1009

(52) U.S. Cl. CPC G06F 12/1009

(57) ABSTRACT

The present disclosure discloses a method and an apparatus of translating a virtual address for processing-in-memory. The virtual address translating method of the present disclosure includes determining a data operand for processing-in-memory to be shared with a processor-in-memory, by a CPU, searching a page table corresponding to the data operand from a memory, defining an address space of the determined data operand in an operand address space which is divided into a plurality of sub spaces and generating an operand page table according to the defined address space, by the CPU, and determining a physical address for the determined data operand, using the operand page table, by the processor-in-memory.

### CROSS-REFERENCE TO RELATED APPLICATIONS

This application claims priority to and the benefit of Korean Patent Application No. 10-2023-0172560 filed in the Korean Intellectual Property Office on Dec. 1, 2023, the entire contents of which are incorporated herein by reference.

### BACKGROUND

### Field

The present disclosure relates to a method and an apparatus of translating a virtual address for processing-in-memory, and more particularly, to a method and an apparatus of translating a virtual address according to an applied application into a physical address.

### Description of the Related Art

FIG. 1 illustrates a related art of a virtual memory system and a page table. In FIG. 1, a core of the CPU is driven based on a virtual memory system. Each user program of the CPU has an own virtual address space and an operating system of the CPU divides virtual address spaces by a page unit having a predetermined size and then allocates the divided virtual address space to a physical address space of the memory device.

FIG. 2 is a conceptual view for explaining a page table according to the related art. A CPU records virtual-physical mapping information in a page table which is a specialized management method, as data structure through its own illustrated in FIG. 2 and stores the virtual-physical address mapping information in a memory. In the case of 64-bit structure, for the versatility, the page able of FIG. 2 is implemented to have a four-step hierarchy. The four-step hierarchy of the related art, as illustrated in FIG. 2, requires four memory readings during an address translation process, which may cause the large performance degradation in processing-in-memory.

The virtual memory support is a major challenge for near-memory processing. Even though existing related arts have also addressed the challenges, there is a practical limitation in that a traditional CPU hardware or memory allocation systems need to be modified. In order to avoid the limitations, a page table specialized for the NMP is used. However, the NMP-specific page table proposed by the related arts have static page table walk latency regardless of data size. This had a problem of long address translation times even for relatively small data.

### SUMMARY

In consideration of the above-described limitations of the related art, an object of the present disclosure is to provide a virtual address translating method which is directly accessible to data of a host processor by translating an address by a processor-in-memory.

Further, an object of the present disclosure is to provide a virtual address translating apparatus which is directly accessible to data of a host processor by self-address translation.

In order to achieve the above-described objects, according to an aspect of the present disclosure, a virtual address translating method for processing-in-memory includes determining a data operand for processing-in-memory to be shared with a processor-in-memory, by a CPU (or a processor); searching a page table corresponding to the data operand from a memory, by the CPU; defining an address space of the determined data operand in an operand address space which is divided into a plurality of sub spaces according to a number or a size of the operand page tables and generating an operand page table according to the defined address space, by the CPU; and determining a physical address for the determined data operand, using the operand page table by the processor-in-memory.

Prior to the determining of a physical address, the virtual address translating method further includes a step of generating memory internal address translating information for the determined data operand and transmitting the memory internal address translating information to the processor-in-memory, and determining a physical address for the determined data operand, further using the operand page table and the memory internal address translating information by the processor-in-memory.

In the present disclosure, the memory internal address translating information includes at least one selected from a group consisting of a start virtual address, an end virtual address, a start operand address, an operand page table basic address, and operand page table type information.

The operand address space which is divided into the plurality of sub spaces has a distribution which is spaced apart from each other in a virtual address space and an operand page table structure is different according to the sub space.

The processor-in-memory of the present disclosure further includes an address translator and the address translator of the processor-in-memory determines a physical address for the determined data operand regardless of a structure of the CPU.

The present disclosure provides a computer program which is stored in a computer readable storage medium to allow a computer to execute the virtual address translating method for processing-in-memory.

In order to achieve another object of the present disclosure, according to an aspect of the present disclosure, a virtual address translating apparatus for processing-in-memory includes a CPU and a memory which stores execution instructions for translating a virtual address and includes a processor-in-memory, steps performed by the CPU by executing the execution instructions include: determining a data operand for processing-in-memory to be shared with a processor-in-memory, by a CPU; searching a page table corresponding to the data operand from a memory, defining an address space of the determined data operand in an operand address space which is divided into a plurality of sub spaces according to a number or a size of operand page tables, and generating an operand page table according to the defined address space, and transmitting the operand page table to the processor-in-memory, by the CPU and the processor-in-memory determines a physical address for the determined data operand, using the operand page table.

Prior to the determining of a physical address, the CPU further performs a step of generating memory internal address translating information for the determined data operand and transmitting the memory internal address translating information to the processor-in-memory. The processor-in-memory determines a physical address for the determined data operand, further using the operand page table and the memory internal address translating information.

The processor-in-memory of the present disclosure further includes an address translator and the address translator of the processor-in-memory determines a physical address for the determined data operand regardless of a structure of the host CPU.

The address translator of the processor-in-memory includes a translation lookaside buffer (TLB) which caches page table information and a page table walker (PTW) which accesses a page table stored in the memory to fetch mapping information.

Prior to searching whether the page table corresponding to the data operand is in the memory, the CPU searches whether the page table is stored in the translation lookaside buffer first and the page table walker searches the page table stored in the memory with reference to an address of a page table stored in a register of the CPU.

The address translator of the present disclosure further includes a virtual address-operand address converter (VOC) and a walker cache. The page table walker obtains information for translating an operand address into a physical address using information stored in the walker cache based on the operand address information received from the VOC.

According to the present disclosure, a processor-in-memory translates the address by itself to be directly accessible to the data of the host processor. Further, according to the present disclosure, like the existing acceleration method, there is no need to copy data before and after acceleration operation and further a cost for sharing data between a host processor and a processor-in-memory is significantly reduced.

Further, according to the present disclosure, unnecessary memory usage is reduced by eliminating data replication for internal operation and an address translation speed may be improved by improving an intermediate pointer sharing method and a page table structure when the metadata is replicated. Consequently, there is an advantage in that the entire operation performance of the processor-in-memory is improved.

### BRIEF DESCRIPTION OF THE DRAWINGS

FIG. 1 illustrates a related art of a virtual memory system and a page table;

FIG. 2 is a conceptual view for explaining a page table according to the related art;

FIG. 3 is a block diagram illustrating a virtual address translating apparatus according to an exemplary embodiment of the present disclosure;

FIG. 4 is a referential view for explaining a concept for an address translating method according to an exemplary embodiment of the present disclosure;

FIG. 5 is a diagram illustrating memory internal address translating information according to an exemplary embodiment of the present disclosure;

FIG. 6 is a referential view illustrating a structure of an operand page table employed by the present disclosure;

FIG. 7 is a referential view illustrating an address supporting range according to every type of an operand page table;

FIG. 8 is a block diagram of a structure of an address translator 2220, according to an exemplary embodiment of the present disclosure;

FIG. 9 is a detailed block diagram of a virtual address-operand address converter (VOC) 2222 illustrated in FIG. 8;

FIG. 10 is a flowchart illustrating a virtual address translating method which is time-serially performed in a processor-in-memory, according to an exemplary embodiment of the present disclosure;

FIG. 11 illustrates how the scheme of the present disclosure supports a virtual memory for a near memory accelerator which accelerates a kernel with three data operands;

FIG. 12 is a referential view for explaining a setting of an index according to a type of an OAS;

FIG. 13 is a referential view illustrating an example of generating an OAS (operand address space); FIG. 14 is an example for an algorithm for generating an OAS; and

FIG. 15 is a referential view for specifically illustrating an operation principle of the present disclosure.

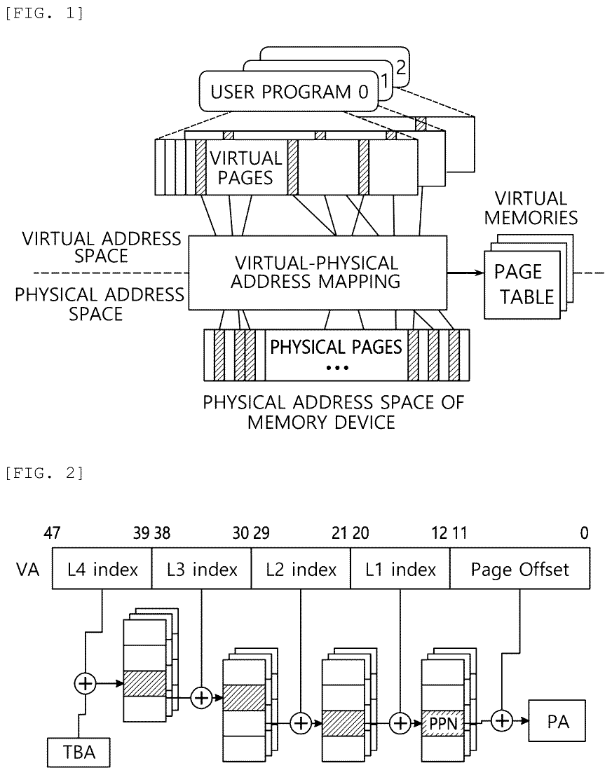

### DETAILED DESCRIPTION OF THE EMBODIMENT

Hereinafter, exemplary embodiments of the present disclosure will be described in detail with reference to the accompanying drawings. In the description of the present disclosure, if it is considered that the specific description of related known configuration or function may cloud the gist of the present disclosure, the detailed description will be omitted. Further, hereinafter, exemplary embodiments of the present disclosure will be described. However, it should be understood that the technical spirit of the invention is not restricted or limited to the specific embodiments, but may be changed or modified in various ways by those skilled in the art to be carried out. Hereinafter, a method of translating a virtual address for processing-in-memory proposed by the present disclosure will be described in detail with reference to the drawings.

The present disclosure discloses a method for directly accessing data of a host processor by translating an address by itself in a processor-in-memory (hereinafter, an internal processor) during the processing-in-memory. Specifically, the present disclosure discloses a sharing method of address mapping meta data of a host processor of self-address translation of the processor-in-memory. Further, the present disclosure provides a new page table structure and an address translation module of a processor-in-memory.

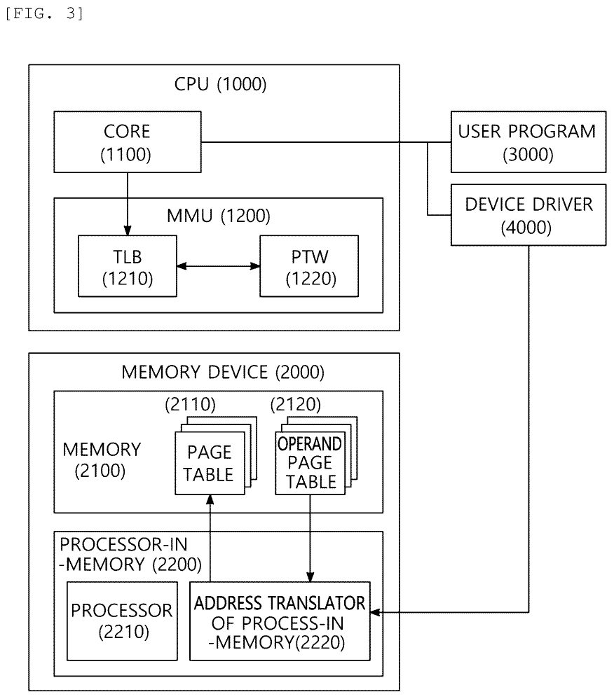

“Page table walk” refers to an act of an address translator which accesses a page table to obtain mapping information. During the process of performing page table walk, it accesses a top entry of a page table which is generated in the form of a tree and then identifies an address of a subsequent step by steps, and then finally reaches a bottom entry which stores mapping information by accessing with an identified address. For example, in FIG. 2, one page table walk operation requires four memory readings which is the number of steps of the page table.

The present disclosure discloses a technique based on an operand for supporting a virtual memory. A scheme of the present disclosure allocates a sharing space based on a size of operand data without determining a size of a space to be shared in advance. That is, a flexible page table is used to achieve an effect of reducing delay of the page table walk. Specifically, desirably, a page table hierarchy for a size of the shared space is applied to the flexible page table of the present disclosure.

As an exemplary embodiment of a virtual address translating apparatus of the present disclosure, hereinafter, a detailed operation principle will be described with an implementation example including a memory device including a CPU and an internal processor. In the present disclosure, the CPU may be a host CPU or a processor which processes an operation related to a memory. An operation of translating an operand address, which is one technical feature among technical features of the present disclosure, into a physical address is substantially performed by a processor-in-memory. Further, when a processing unit which performs an operation related to page table search and operand page table generation to be described below is embedded in a memory device, the virtual address translating apparatus of the present disclosure is interpreted as a meaning of a memory device in which an address translator and a processing unit are embedded. Further, according to still another exemplary embodiment of the present disclosure, the CPU may also be implemented as a processing unit which is embedded in the memory device or an accelerator which is separately provided.

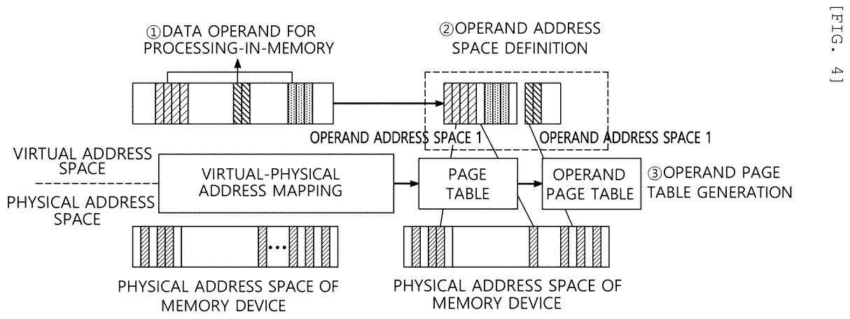

FIG. 3 is a block diagram illustrating a virtual address translating apparatus according to an exemplary embodiment of the present disclosure. A virtual address translating apparatus illustrated in FIG. 3 includes a CPU 1000, a memory device 2000, a user program 3000, and a device driver 4000. In the present exemplary embodiment, the CPU is denoted to be exchangeable to a host CPU. Further, the CPU may be implemented by various types of processing devices which interpret and execute instructions of the computer.

In the example of FIG. 3, the CPU 1000 includes a core 1100 and a memory managing unit (MMU) 1200 and the MMU 1200 includes a TLB 1210 and a PTW 1220. Hereinafter, the CPU is a processor which defines an operand address space separated from an existing virtual address space in the virtual address translating apparatus of the present disclosure and generates an operand page table. In the present exemplary embodiment, the CPU may be interpreted as a concept including a host CPU, a processor, or a signal processing device which executes an operation and a control operation according to a program.

The CPU 1000 performs an operation of performing a virtual-physical address translation operation in real time and more particularly, the operation is performed by the memory management unit (MMU) (1200) in the CPU.

The memory management unit (MMU) 1200 of the CPU includes a translation lookaside buffer (TLB) 1210 which caches only page table information and a page table walker (PTW) 1220 which accesses a page table in the memory to fetch desired mapping information.

The memory management unit (MMU) 1200 accesses the page table by means of OS and performs an address translation task. The memory management unit may be provided in the CPU, and also may be implemented as a separate chip which is provided at the outside of the CPU.

Here, the table walker unit refers to a logic which reads a translation table from a memory. The translation lookaside buffer (TLB) is a hardware cache which stores a page table entry which is frequently referenced. The memory management unit translates a virtual address into a physical address by means of the TLB which stores the page mapping metadata. When there is an error in the translation lookaside buffer, the page table walker unit accesses a page table in the main memory to search table mapping metadata. This method gives a significant challenge, for example, to a near memory accelerator (NMACC) to access the main memory. The NMACC receives a task from the host processor so that an address of the operand data is based on VAS. However, the main memory stores operand data in the PAS and VA-to-PA mapping information is obtained by means of the page table. Therefore, in order to access data of the main memory, the NMACC needs to solve the VA-to-PA mapping to support the virtual memory.

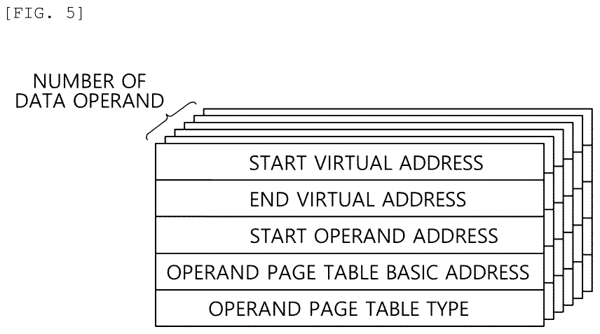

FIG. 4 is a referential view for explaining a concept for an address translating method according to an exemplary embodiment of the present disclosure. In FIG. 4, the CPU records the VA-to-PA mapping information in a page table having a specific data structure and the page table is stored in the memory.

The CPU 1000 determines a data operand for processing-in-memory to be shared with the processor-in-memory 2200.

After selecting data operands to be shared with the processor-in-memory, the CPU 1000 searches mapping information of the virtual address from the page table 2110 stored in the memory 2100 by means of the device driver 4000. For example, by means of the search of the mapping information, a virtual address in which operand data exists and a size of the data operand may be identified.

The CPU 1000 duplicates searched mapping information to move data operands corresponding to the existing virtual address space to a newly defined operand address space as illustrated in FIG. 4 (2), based on a data size to be newly defined. In the operand address space, operand page addresses may have a value which is added or subtracted by a movement interval, for every operand, in the virtual address space.

The CPU 1000 reconstructs an operand page table having an improved structure based on an operand address space, by means of the device driver 4000 (FIG. 4(3)). The CPU stores an operand page table 2120 according to a newly defined address space in the memory.

For example, a data operand to be shared is divided into five types according to an operand address space size. Types other than Type 5 have a smaller size than the virtual address space of the CPU to be allowed to have a smaller hierarchy so that an address translation speed is improved.

Here, the types may be distinguished according to a size of the data operand or a number of pages of the data operand. The CPU generates an operand address space for every type by considering a type of a current data operand. Here, the size of the data operand refers to a size of an address space of the data operand occupied in the virtual address space.

The CPU 1000 generates an improved operand page table and a memory internal address translating information by means of the device driver 4000 and transmits the generated information to the address translator 2220 of the processor-in-memory 2200.

Here, the memory internal address translating information is translation information between a virtual address space and an operand address space.

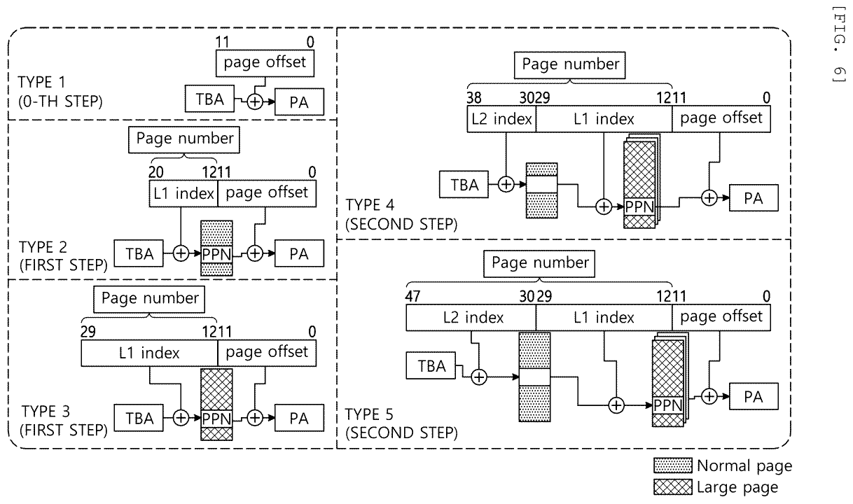

FIG. 5 is a diagram illustrating memory internal address translating information an according to an exemplary embodiment of the present disclosure. “Address translating information” contains information required for the address translator 2220 of the processor-in-memory 2200 to translate an “operand address” into a “physical address”. The host CPU collects elements required for address translating information during a process of generating an operand address space and an operand page table to generate address translating information for every data operand. Here, the generated address translating information for every operand is transmitted to the address translator 2220 of the processor-in-memory. The address translator of the processor-in-memory 2200 accesses the operand page table based on the address translating information to translate the “operand address” into a “physical address” to obtain the physical address.

The “address translating information” which is newly proposed in the present disclosure includes one or a plurality of information selected from a start virtual address, an end virtual address, a start operand address, an operand page table basic address or an operand page table type.

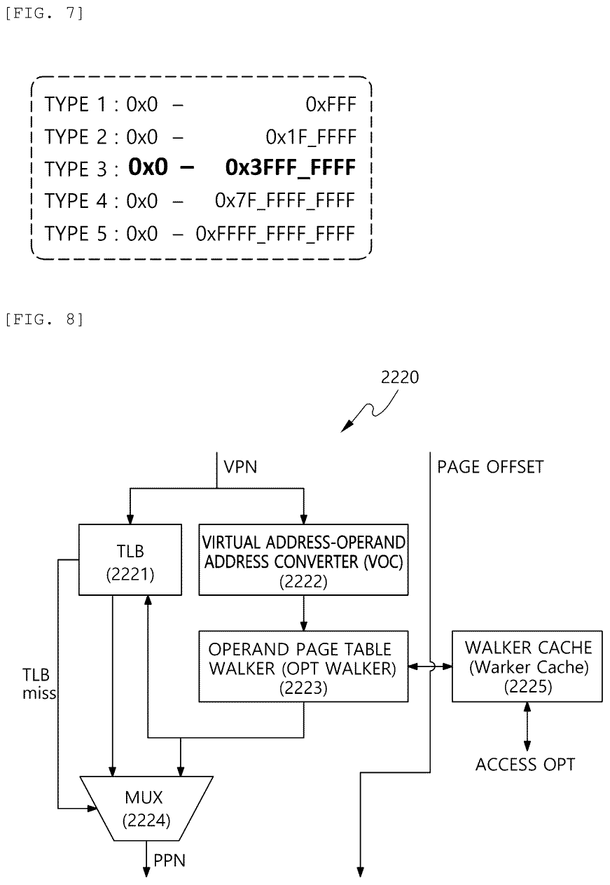

Here, the start virtual address refers to a start address of an operand in the virtual address space (existing address space). The end virtual address refers to a last address of an operand in the virtual address space (existing address space). The start operand address indicates a start address of the operand in the operand address space (an address space generated in the present disclosure). The operand page table basic address contains a start position of an operand page table (a table containing matching information for “operand address->physical address” translation generated in the present disclosure) in the memory. The operand page table type refers to a type for distinguishing an operand page table according to a predetermined criterion. In the present exemplary embodiment, examples of types 0, 1, 2, 3, and 4 (see FIGS. 6, 7, and 12) are proposed.

The memory device 2000 according to the exemplary embodiment of the present disclosure includes a memory 2100 and a processor-in-memory 2200. The memory 2100 includes a page table 2110 and an operand page table 2120. The processor-in-memory 2200 includes a processor 2210 and an address translator 2220.

In the present exemplary embodiment, the processor-in-memory 2200 translates the address based on the page table for processing-in-memory by means of the address translator 2220. In the present disclosure, the processor-in-memory may be associated with a method of duplicating or distinguishing a page table for the accelerator. The processor-in-memory 2200 shares an address space with the CPU 1000 so that it is advantageous to perform an operation without a task of duplicating data in a memory of an acceleration device by a CPU as in an existing acceleration technique.

In order to allow the processor-in-memory to directly access data of the CPU, the address translator of the processor-in-memory needs to identify mapping between a virtual address space operated by an operating system of the CPU and a physical address space of the memory and translate the address by itself. In various cases, the CPU and the address translator have various structures, respectively so that the address translating method based on a page table may be different. The memory device cannot identify the type of host CPU, but the address translation compatibility of all CPU architectures to the MMU is an important issue. However, in order to achieve the address translation compatibility, there is a problem in that the complexity of the architecture becomes very high.

The processing acceleration of the CPU is usually based on the data operands. However, in the present disclosure, the mapping information for the data operands are duplicated and reconstructed to separately create an operand page table for processing-in-memory and the processor-in-memory 2200 translates the address by itself regardless of the CPU architecture.

As illustrated in FIG. 3, in the memory device 2000, a processor-in-memory 2210 which shares the memory with the host CPU is separately present. The host CPU offloads a part of the processing to the processor 2210 to improve the performance of the system.

The user program 300 transmits processing information to the memory processor and requests the device driver 4000 to transmit the address translating information to offload the processing. The device driver 4000 generates an operand page table based on the data operand information transmitted from a user program.

The device driver 4000 transmits an operand page table and memory internal address translating information to the address translator of the processor-in-memory. The processor-in-memory performs the processing based on the virtual address and the address translator performs a translation process in the order of a virtual address-operand address-physical address inside.

The CPU searches a page table corresponding to the data operand from the memory through the device driver 4000. Further, the CPU generates the operand page table based on data operand information transmitted from the user program 3000, using the device driver 4000.

The searching delay of the operand page table may be directly associated with a number of levels, in the page table hierarchy. The CPU page table manages page mapping metadata so that the page table may be implemented as a normal page (for example, 4 KB) for the sake of resource efficiency. The page table may store page mapping metadata of VMA of the operand to be shared. The operand page table of the present disclosure is defined to have a reduced hierarchy.

According to still another exemplary embodiment of the present disclosure, in the virtual address translation apparatus of the present disclosure, the above-described CPU is i) implemented such that a CPU or a processing unit which performs the substantially same operation as the CPU are embedded in the memory device or ii) implemented as a near memory accelerator which is adjacent to the memory device. In this case, the description from the view point of the above-described CPU is also applied to the embedded CPU and near memory accelerator within the scope which does not impair the technical feature of the present disclosure. Although the present specification is explained through an example of a configuration of a CPU and a memory device, the scope of the present disclosure should be interpreted to include various implementation examples in the scope of maintaining the technical feature of the present disclosure such as i) and ii).

FIG. 6 is a referential view illustrating a structure of an operand page table employed by the present disclosure. FIG. 7 is a referential view illustrating an address supporting range according to every type of an operand page table.

The operand page table of the present disclosure has a hierarchy which is different according to a characteristic of a subject address space. For example, an operand page table with a structure in which hierarchies are integrated according to a size of the address space or using a large page of 2 MB or larger in addition to a normal page of 4 KB may be implemented. A page managed by an operating system of the virtual address translation apparatus of the present disclosure is divided into a normal page (for example, 4 KB) and a large page (for example, 2 MB).

The operand page table proposed by the present disclosure has a structure compressed to at most two steps by defining four-step page table structure of the existing CPU as an address system of a normal page and a large page. The operand page table may have various types (for example, five types) according to an address space size of the operand. For example, a first type is an operand configured with only one page and a physical address (PA of FIG. 5) is obtained by adding a page offset to an operand page table basic address (TBA of FIG. 5). Second and third types may be supported by one address system of the normal page and the large page, respectively.

A page number (see FIG. 6) is the same as an index (L1 index in FIG. 6) in the first step page table and TBA indicates an address of a first step page table. Accordingly, a physical page number (PPN in FIG. 6) is known by adding L1 index to the TBA (first step) and PA is obtained by adding PPN and the page offset. Fourth and fifth type may support the address with “normal page+large page” or “large page×2”. The fifth type may support the same address range as the CPU. Unlike the second and third types, the page number is configured by L2 index (an index in a second step page table)+L1 index and TBA indicates an address of the second step page table. Accordingly, an address of the first step page table is known by adding TBA and L2 index and L1 index is added thereto to obtain the PPN. Further, the PA is obtained by adding PPN and the page offset.

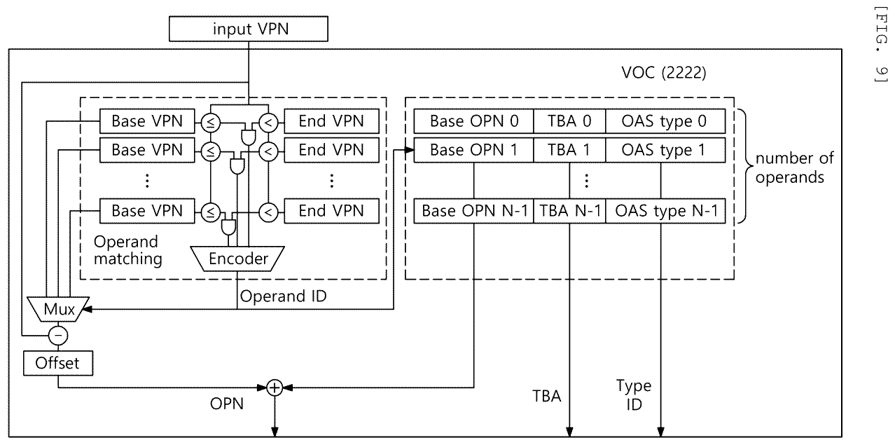

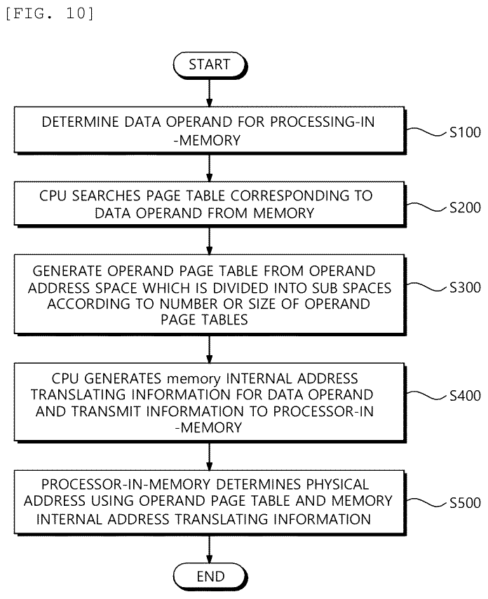

FIG. 8 is a block diagram of a structure of an address translator 2220, according to an exemplary embodiment of the present disclosure. FIG. 9 is a detailed block diagram of a virtual address-operand address converter (VOC) 2222 illustrated in FIG. 8.

The address translator 2220 illustrated in FIG. 8 includes a TLB 2221, a virtual address-operand address converter (VOC) 2222, an operand page table walker (OPT) 2223, a MUX 2224, and a walker cache 2225. Here, the virtual page number (VPN) is a remaining excluding a page offset (lower 12 bits) from a virtual address (VA).

An operand page number (OPN) is an address obtained by converting the VPN of the operand by means of the VOC and is used to access an operand page table. The virtual-to-operand converter (VOC) obtains OPN, TBA, and an operand page table type (Type ID) according to the input VPN of the operand. The OPT walker (operand page table walker) accesses the OPT based on the OPN, TBA, and the operand page table type (type ID) obtained through the VOC to obtain the physical address PA. The walker cache is a cache memory device for assisting an OPT access speed. The OPT is present in the memory to be cached for rapid access.

The processor 2210 accesses with a virtual address and the address translator 2220 translates the virtual address of the processor 2210 into a physical address of the memory. The address translator 2220 accesses the TLB first to check whether there is stored virtual-physical address translating information. At this time, the virtual is address transmitted to the VOC 2222 and the VOC transmits the operand address information to the OPT walker using the virtual address. If there is address translating information required for TLB, the address translator 2220 immediately performs the translation and if there is no address translating information required for TLB, transmits a signal to the operand page table walker. The operand page table walker accesses the operand page based on the operand address information received from the VOC to obtain the operand-physical address translating information. The address translator 2220 simultaneously transmits a physical address which will be obtained thereafter to the memory and stores mapping information of the physical information and the virtual information in the TLB.

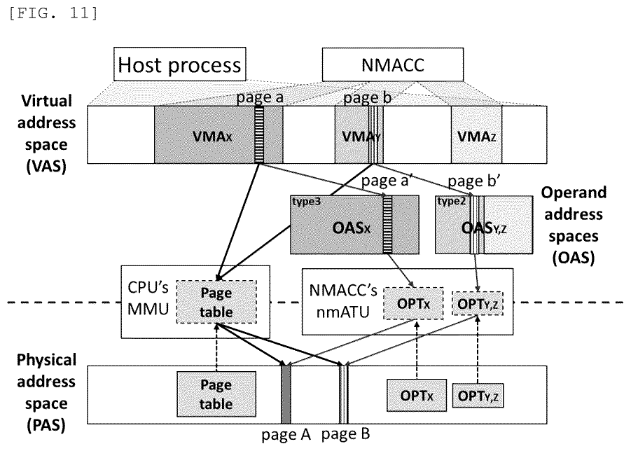

FIG. 10 is a flowchart illustrating a virtual address translating method which is time-serially performed in a processor-in-memory, according to an exemplary embodiment of the present disclosure.

In step S100, the CPU 1000 determines a data operand for processing-in-memory to be shared with the processor-in-memory 2200.

When the CPU 1000 accesses the memory device 2000, the CPU translates the virtual address into the physical address via the MMU 1220 first. Basically, the CPU 1000 accesses the TLB 1210 and if the mapping information in the TLB is stored, immediately performs the physical address translation. However, if there is no desired mapping information in the TLB, the PTW 1220 operates. The PTW performs a page table walk (an operation of finding a mapping degree from the page table) with reference to a page table basic address stored in a specific register.

Next, in step S200, the CPU 1000 or the device driver 4000 searches a page table corresponding to the data operand from the memory.

Next, in step s300, the CPU 1000 defines an address space of the data operand in the operand address space which is divided into a plurality of sub spaces and generates an operand page table according to the defined address space.

In step S200, the CPU confirms a virtual memory address corresponding to the data operand and a size of the address space in the operand page table. The CPU or the device driver determines a type of the data operand by considering a sub space to which the data operand belongs in consideration of a size of the address space of the data operand (or a number of pages) and generates an operand page table according to the determined type of data operand. Next, in step S400, the CPU 1000 generates memory internal address translating information for the data operand and transmits the information to the processor-in-memory 2200. Next, in step S500, the processor-in-memory 2200 determines the physical address using the operand page table and the memory internal address translating information.

Even though in FIG. 10, it is described that the steps are sequentially performed, the present invention is not necessarily limited thereto. In other words, the steps illustrated in FIG. 10 may be changed or one or more steps may be performed in parallel so that it is not limited to a time-series order illustrated in the drawing.

The address translating method according to the exemplary embodiment described in FIG. 10 may be implemented by an application (or a program) and may be recorded in a terminal (or computer) readable recording medium. The recording medium which has the application (or program) for implementing the address translating method according to the exemplary embodiment recorded therein and is readable by the terminal device (or a computer) includes all kinds of recording devices or media in which computing system readable data is stored.

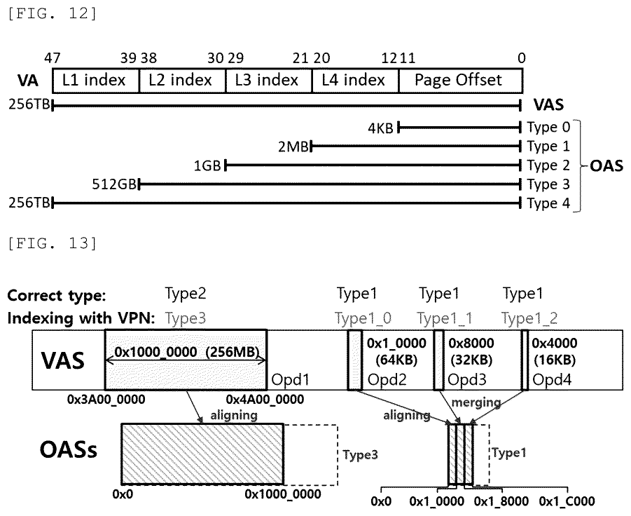

FIG. 11 is a referential view illustrating how the scheme of the present disclosure supports a virtual memory for a near memory accelerator which accelerates a kernel with three data objects. In FIG. 11, a host CPU initializes operands X, Y, and Z for acceleration and a user defines a virtual memory address as a sharing area through the API. In FIG. 11, a software driver and a device driver align X and Y and merge Z. When all sharing areas are defined, the driver constructs an operand page table (OPT) for each OAS (operand address space) and copies page mapping metadata from the page table of the CPU to fill an entry of the operand page table (OPT). After constructing the operand page table, OAS-to-PAS mapping metadata is stored in the memory. VAS-to-OAS is translated by simple address shifting between OA and VA. In the memory accelerator, the memory address translator in the processor-in-memory translates the virtual address into the physical address based on the operand page table. In FIG. 11, when the CPU accesses the virtual pages a and b, the MMU translates the virtual addresses of a and b into physical addresses. During this process, since the OTP y and z have smaller hierarchy than the OPTx, an address translation time for b into B by the near memory address translator nmATU is shorter than the address translation time for a into A.

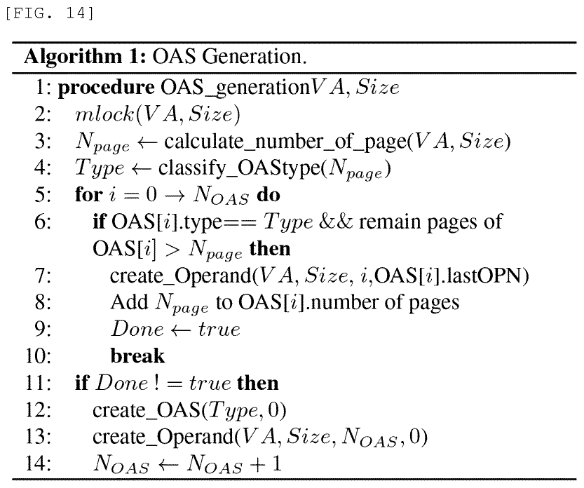

FIG. 12 is a referential view for explaining a setting of an index according to a type of an OAS. As illustrated in FIG. 12, the present disclosure employs a variable page table structure having different address space coverage size. The page table stores page mapping metadata.

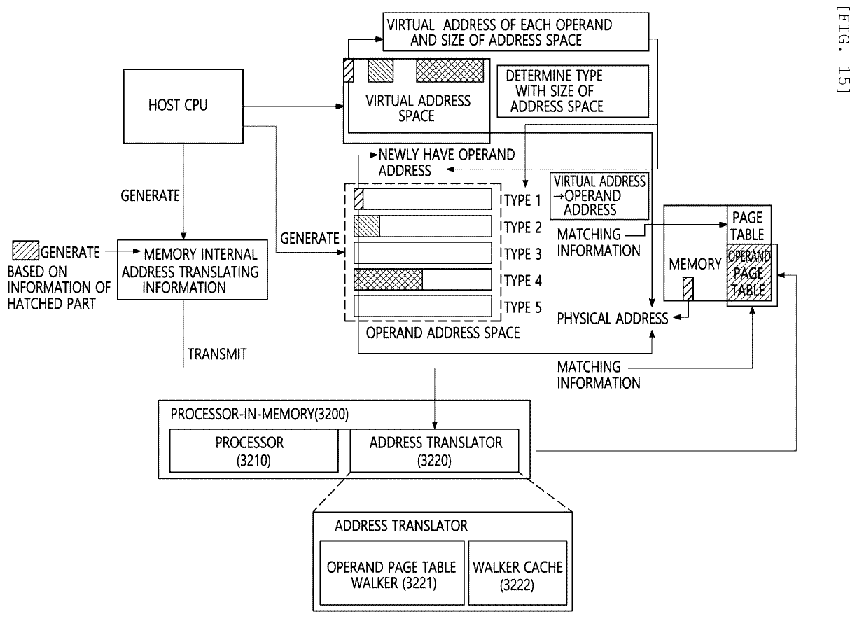

FIG. 13 is a referential view illustrating an example of generating an OAS (operand address space) and FIG. 14 is an example for an algorithm for generating an OAS.

As illustrated in FIG. 13, when a page table having a reduced address space coverage is indexed to VPN, the VMA cannot allocate an appropriate type of the VMA due to a biased VPN value. Opd1 of FIG. 13 has a size of 256 MB and is classified as Type 2. When it is indexed to VPN, it may exceed an address space size of Type 2. It may cause the Opd1 to be allocated to Type 3.

In the present disclosure, a logical address space which is called an address translation space is used. A virtual address of the operand is shifted to generate an address translation space. A operand page number OPNs of the address translation space is used to index the page table. The generation of the address translation space is the same as definition of VMA which is shared with NMACC. The device driver manages a list of OAS and manages the shared VMA using two types of metadata. The OAS metadata is configured by a type and a number of effective pages. The host CPU determines the type of OAS by means of the device driver, according to the number of pages of VMA.

According to still another exemplary embodiment of the present disclosure, the present disclosure starts a virtual memory support scheme based on a page table specified to near memory processing (NMP-specific page table). An object of the present disclosure is to propose a page table structure appropriate for a memory foot print of a near memory accelerator (NMACC) and reduce delay of a page table walker thereby.

The memory foot print of the near accelerator is divided to be allocated to each virtual memory area. These areas are allocated in advance and are initiated by a host CPU through memory allocation APIs, such as malloc or mmap. If a user defines the virtual area of the operand as a sharing area by means of the APIs, a software driver copies page mapping metadata for a virtual memory area of each operand (data operand) to a page table specified to near memory processing, which is called an operand page table. The operand page table has a flexible structure according to a size of the operand data.

The address translating apparatus of the present disclosure includes a near memory address translation unit (nmATU). The near memory address translation unit translates an address based on an operand page table.

In the actual system, prototypes of many memory accelerator partially support the virtual memory. The existing techniques guarantees a dedicated PAS by registering a local memory in a system memory map or reserving a memory for the NMP in a boosting sequence. Next, the user allocates the virtual memory to NMACC dedicated spaces through a specific API. However, the CPU cannot use the NMACC dedicate space for another purpose so that this is not considered as actual memory sharing. The NMACC accesses a dedicated space so that when the address space is dedicated, it means that the NMACC still has a limited memory space and memory resource inefficiency. A workload accelerated by the NMACC often requires a large memory space and this limitation may hinder the NMACC from fully utilizing the corresponding function.

In order to overcome this limitation, the NMACC requires accessing the main memory, just as the CPU resolves the memory mapping of the OS. However, the biggest huddle in this process is an infrastructure of address translation based on the page table. When the page table is duplexed in the NMACCs, there are some challenges such as page table waling latency or compatibility to the page table structure according to an CPU architecture. Some prior studies avoid performing of page table walk in NMACCs using a continuous range memory allocation method. Alternatively, some prior studies adds a hardware module to a host machine which performs address translation on the NMACC. However, these methods requires modification of a CPU hardware, such as translation lookaside buffer (TLB) or a page table walker or addition of modules, so that it is difficult to be actually applied.

FIG. 15 is a referential view for specifically illustrating an operation principle of the present disclosure. As illustrated in FIG. 15, a processor-in-memory 3200 includes a processor 3210 and an address translator 3220.

The address translator 3220 translates the operand address into the physical address by referencing an operand page table, based on the memory internal address translating information. In the “operand page table”, matching information for translation between the operand address and the physical address is stored.

Here, the “operand address” refers to an address in an “operand address space” which is newly proposed in the present disclosure. The “operand address space” is a new address space which is generated based on an “address space size” in a virtual address space (already existing address space) of each operand, by the host CPU for efficient translation of the address of the processor-in-memory.

The address translator 3220 includes an operand page table walker 3221 and a walker cache 3222. The operand page table walker 3221 accesses the operand page table based on operand address information received from the VOC to obtain operand-physical address translating information and performs an address translation operation to translate the operand address into a physical address. The walker cache 3222 is a component employed to improve an access speed to the operand page table.

It will be appreciated that various exemplary embodiments of the present disclosure have been described herein for purposes of illustration, and that various modifications and changes may be made by those skilled in the art without departing from the scope and spirit of the present invention. Accordingly, the exemplary embodiments of the present disclosure are not intended to limit but describe the technical spirit of the present invention and the scope of the technical spirit of the present invention is not restricted by the exemplary embodiments. The protective scope of the embodiment of the present disclosure should be construed based on the following claims, and all the technical concepts in the equivalent scope thereof should be construed as falling within the scope of the embodiment of the present disclosure.

What is claimed is:

1. A virtual address translating method for processing-in-memory, comprising:
determining a data operand for processing-in-memory to be shared with a processor-in-memory, by a CPU;
searching a page table corresponding to the data operand from a memory, by the CPU;
defining an address space of the determined data operand in an operand address space which is divided into a plurality of sub spaces and generating an operand page table according to the defined address space, by the CPU; and
determining a physical address for the determined data operand, using the operand page table, by the processor-in-memory.

2. The virtual address translating method for processing-in-memory according to claim 1, wherein prior to the determining of a physical address, the CPU further performs a step of generating memory internal address translating information for the determined data operand and transmitting the memory internal address translating information to the processor-in-memory,
the step of determining a physical address by the processor-in-memory further includes:
determining a physical address for the determined data operand, further using the operand page table and the memory internal address translating information.

3. The virtual address translating method for processing-in-memory according to claim 2, wherein the memory internal address translating information includes at least one selected from a group consisting of a start virtual address, an end virtual address, a start operand address, an operand page table basic address, and operand page table type information.

4. The virtual address translating method for processing-in-memory according to claim 1, wherein the operand address space which is divided into the plurality of sub spaces has a distribution which is spaced apart from each other in a virtual address space and an operand page table structure is different according to the sub space.

5. The virtual address translating method for processing-in-memory according to claim 1, wherein the processor-in-memory further includes an address translator and the address translator of the processor-in-memory determines a physical address for the determined data operand regardless of a structure of the CPU.

6. The virtual address translating method for processing-in-memory according to claim 5, wherein the address translator includes a translation lookaside buffer (TLB) which caches page table information and a page table walker (PTW) which accesses a page table stored in the memory to fetch mapping information.

7. The virtual address translating method for processing-in-memory according to claim 6, wherein prior to searching whether the page table corresponding to the data operand is in the memory, the CPU searches whether the page table is stored in the translation lookaside buffer first.

8. The virtual address translating method for processing-in-memory according to claim 6, wherein the page table operator searches the page table stored in the memory with reference to an address of a page table stored in a register of the CPU.

9. A computer program which is stored in a computer readable storage medium to allow a computer to execute the virtual address translating method for processing-in-memory according to claim 1.

10. A virtual address translating apparatus for processing-in-memory, comprising:
a CPU and a memory which stores execution instructions for translating a virtual address and includes a processor-in-memory,
wherein steps performed by the CPU by executing the execution instructions include:
determining a data operand for processing-in-memory to be shared with a processor-in-memory, by the CPU;
searching a page table corresponding to the data operand from a memory, defining an address space of the determined data operand in an operand address space which is divided into a plurality of sub spaces according to a number or a size of operand page tables, and generating an operand page table according to the defined address space,
the processor-in-memory determines a physical address for the determined data operand, using the operand page table.

11. The virtual address translating apparatus for processing-in-memory according to claim 10, wherein prior to the determining of a physical address, the CPU further performs a step of generating memory internal address translating information for the determined data operand and transmitting the memory internal address translating information to the processor-in-memory, and
the processor-in-memory determines a physical address for the determined data operand, further using the operand page table and the memory internal address translating information.

12. The virtual address translating apparatus for processing-in-memory according to claim 11, wherein the memory internal address translating information includes at least one selected from a group consisting of a start virtual address, an end virtual address, a start operand address, an operand page table basic address, and operand page table type information.

13. The virtual address translating apparatus for processing-in-memory according to claim 10, wherein the processor-in-memory further includes an address translator and
the address translator of the processor-in-memory determines a physical address for the determined data operand regardless of a structure of the CPU.

14. The virtual address translating apparatus for processing-in-memory according to claim 13, wherein the address translator includes a translation lookaside buffer (TLB) which caches page table information and an operand page table walker (PTW) which accesses a page table stored in the memory to fetch mapping information.

15. The virtual address translating apparatus for processing-in-memory according to claim 14, wherein prior to searching whether the page table corresponding to the data operand is in the memory, the CPU searches whether the page table is stored in the translation lookaside buffer first and the page table walker searches the page table stored in the memory with reference to an address of a page table stored in a register of the CPU.

16. The virtual address translating apparatus for processing-in-memory according to claim 14, wherein the address translator further includes a virtual address-operand address translator (VOC) and a walker cache and
the page table walker obtains information for translating an operand address into a physical address using information stored in the walker cache based on the operand address information received from the VOC.
